(19) United States
(12) Patent Application Publication
(10) Pub. No.: US 2002/0043501 A1
(43) Pub. Date: Apr. 18, 2002

(54) Process for treating liquid streams to remove unwanted impurities

(76) Inventor: Robert L. Irvine, Overland Park, KS (US)

Correspondence Address: Dan Cleveland, Lathrop & Gage L.C., Suite 302, 4845 Pearl East Circle, Boulder, CO, 80301, US

(21) Appl. No.: 09/934,759

(22) Filed: Aug. 22, 2001

Related U.S. Application Data
(60) Provisional application No. 60/226,962, filed on Aug. 22, 2000.

(51) Int. Cl. B01D 24/00; B01D 29/62

(52) U.S. Cl. 210/661; 210/660; 210/263

(57) ABSTRACT

A continuous adsorption facility is used to purify a liquid stream that contains impurities. A solid adsorbent is used having a special affinity for the impurities over the desired components in the liquid feed. An adsorber is constructed, employing gravity for the transfer of adsorbent between stages with a series of stages each having fluidized beds with limited bed expansion characteristics where the solid adsorbent countercurrent-contacts the upwardly flowing fresh feed introduced at the base. The adsorbent is regenerated with return of most of the desired components from the porous solids becoming part of the adsorber-treated product. Impurities are further removed during regeneration and disposed of separately. Using a novel regeneration arrangement, the reactivating gas may be reduced to below 4% of prior requirements. Capital investment and operating costs economically afford ultra-low sulfur clean gasoline meeting standards imposed by auto manufacturers worldwide.

### RELATED APPLICATIONS

This application claims benefit of priority to provisional application Ser. No. 60/226,962 filed on Aug. 22, 2000, which is hereby incorporated by reference to the same extent as though fully disclosed herein.

### FIELD OF THE INVENTION

This invention pertains to method and apparatus for treating liquids that contain unwanted impurities for which a selective adsorbent has affinity over desired components. More specifically, the impurity-bound adsorbent may be regenerated and recycled for additional use in removing the impurities.

### DESCRIPTION OF THE PRIOR ART

An immediate requirement concerns the purification of liquid streams to remove impurities down to levels that have heretofore not been required on a large scale production basis. For example, there is an urgent need to reduce the sulfur content of liquid gasoline to lower levels of about 5 ppm by weight, which automobile manufacturers require to meet increasingly stringent environmental regulations.

It is a problem in the art that existing technologies cannot acceptably reduce the sulfur content of the olefinic compounds of gasoline. In particular, fluid catalytic cracker (FCC) gasoline generally account for approximately 40% of the United States gasoline refinery production while coker-produced light gasoline constitutes approximately 4% of the United States gasoline production from the West Coast and Gulf Coast refineries. hydrocarbon feedstocks in refineries having fluid catalytic crackers (FCC), where the heteroatom compounds may poison the catalyst. Prior technologies include hydrotreating processes, caustic extraction processes, and bed adsorption processes. In combination, these streams account for more than 90% of the sulfur content in the gasoline stream. Traditional methods for sulfur removal from FCC feedstocks include hydrotreating, caustic extraction, and unsteady state/fixed bed adsorption.

Hydrotreating FCC feedstocks may lower the sulfur content in refined petroleum products, such as gasoline, but yield benefits are marginal after reducing the nitrogen heteroatom content below approximately 600 ppm by weight. Hydrotreating processes remove a portion of the sulfur components from a hydrocarbon feed stream by reacting the sulfur components with hydrogen gas in the presence of a suitable catalyst to form hydrogen sulfide. Hydrogen sulfide is removed from the product gas stream using an amine wash solvent followed by conversion of the hydrogen sulfide to elemental sulfur in a Claus plant. The hydrotreating process scheme usually involves mixing of a hydrocarbon feed stream with a hydrogen-rich gas and, thereafter, heating and passing the hydrocarbon/gas mixture through a catalyst bed in a reactor. The reactor product is cooled and separated into a gas and liquid phase. The off-gas, which contains hydrogen sulfide, is discharged to a Claus plant for further processing. Gasoline feed hydrotreating facilities, even those using selective catalyst to better [preserve the octane quality, have heightened capital cost, have relatively high utility consumption, and require fixed heaters. At present, only about one-third of FCC feedstocks are hydrotreated.

Caustic extraction processes, such as those using mercaptan oxidation (merox) processes, or those offered by Merichem of Houston, Tex., are capable of extracting sulfur from hydrocarbon in the form of mercaptan compounds. Mercaptans are corrosive compounds, which must be extracted or converted to meet a copper strip test. Sodium mercaptides are typically formed and dissolved in a caustic solution, which warmed and then oxidized with air with a catalyst in a mixer column to converts the mercaptides to disulfides. The disulfides are soluble in the caustic only for the lower carbon number mercaptans, and must be separated from the caustic for recycling purposes. Caustic is recycled for mercaptan extraction. The treated hydrocarbon is usually washed with water to reduce the sodium content in the treated product. The caustic extraction processes, however, are capable of extracting sulfur only in the form of mercaptan compounds. Mercaptan compounds account for less than 10% of the sulfur that is present in a FCC gasoline.

Caustic extraction problems include: generation of such hazardous liquid waste streams as spent caustic; smelly gas streams arising from the fouled air effluent resulting from the oxidation step; and the disposal of the disulfide stream. Further, merox processing problems include difficulties associated with handling of a sodium and water contaminated product. Caustic extraction is usually able to remove lighter boiling mercaptans while other sulfur components, such as sulfides and thiophenes, remain in the treated product streams. Accordingly, some disulfides are introduced into the caustic-treated product, typically, when the caustic from the oxidation step is directly recycled for mercaptan extraction. Caustic extraction processes suffer decreasing amounts of extraction for each carbon atom that is added to the mercaptan compound. Caustic extraction processes do not appreciably extract sulfur compounds other than mercaptans; the nitrogen compounds, such as nitrites; or the oxygen compounds, such as peroxides; all of which remain in the feedstocks to create downstream problems.

Unsteady state/fixed bed adsorbers have also, in the past, been used as a means to remove a portion of pollutants when batch adsorption is permitted. The process scheme calls for a hydrocarbon stream containing a pollutant to be passed down through the relatively deep bed of adsorbent, which is initially free of the pollutant to be adsorbed. The top layer of adsorbent contacts the contaminated hydrocarbon entering the stream and is the first portion to adsorb the pollutants. The adsorbent will becomes progressively saturated with pollutant causing a breakthrough of the pollutant at the outlet of the adsorber vessel from which a product stream is issuing. Accordingly, the pollutant-saturated adsorbent bed must be cycled off line and regenerated by raising the temperature of the adsorbent to a level causing a release of the pollutant from the adsorbent. The temperatures of the adsorbent, and the vessel containing the adsorbent, are raised usually by means of passing a hot gas reactivating medium through the adsorbent bed. This gas also carries the released pollutants from the adsorbent bed. Following regeneration, the adsorbent and vessel are cooled and cycled back on line. Problems arise, however, because the stream carrying the pollutants must be disposed of in an environmentally safe manner. The batch cycling process subjects the equipment, utilities, and the adsorbent, to cyclic heating and cooling, and thereby increases the quantity of both the adsorbent and reactivating medium required for the process. Furthermore, a significant portion of the adsorbent, when regenerated, under the batch process contains low levels of deposited heteroatoms. This portion corresponds to approximately half of the required for adsorption in the mass transfer zone associated with the batch processes.

U.S. Pat. No. 5,730,860, entitled Process for Desulfurizing Gasoline and Hydrocarbon Feedstocks, which is incorporated by reference to the same extent as though fully replicated herein, describes a method and apparatus for continuously removing impurities from a hydrocarbon stream through use of a selective particulate adsorbent that is subsequently regenerated and recycled. The process described therein has several disadvantages, particularly, with the continuing evolution of requirements for ever more stringent low sulfur levels. The process requires a significant amount of the catalytic reformer hydrogen output for use as a reactivity gas in the regenerator section. Although the hydrogen is recovered in downstream units, a number of potential refiners have determined that supplying such a large quantity of gas could be a major concern. Further, processing the entire stream of impurity byproduct liquid, which contains predominantly heteroatom compounds, has disadvantages in the context of processing this liquid as part of an existing higher pressure unit. Such processing usually downgrades a potential high octane stream to a lower grade catalytic reformer feedstock and increases the olefin concentration, hence, requiring saturation of the resultant olefins with additional hydrogen. The octane quality of the adsorber treated product also suffers because the desired hydrocarbon in the adsorbent pores has a higher octane number than that of the feedstock.

New insights are required to meet the sulfur levels in motor gasoline desired by the automobile manufacturers, namely, gasoline with no greater than 5 ppm by weight sulfur content. Improved treatments of olefinic feedstocks are required because FCC processes are becoming increasingly significant. Many FCC feedstocks are not hydrogenated. Many of the existing facilities in United States refineries are presently incapable of meeting stringent standards for motor vehicle sulfur removal that will become effective in the near future. Furthermore, other olefinic gasoline components, such as visbreaker gasoline or pyrolysis gasoline in refineries abroad, in addition to coker naptha feedstreams that are prevalent in United States refineries, may in combination with FCC components account for as much as 65 percent by liquid volume of the motor gasoline pool in a given refinery.

### SUMMARY OF THE INVENTION

The present invention overcomes the problems that are outlined above and advances the art by providing improved method and apparatus, also using continuous adsorption, to improve process efficiencies in the removal of impurities from liquid flow streams. These improvements pertain to increased the yield of adsorption treated product; improved quality in the treated product, such as improving the octane number for gasoline feedstocks; and reduction of the utilities that are required to process a given liquid flow stream through use of superior regeneration processes and apparatus. Additional advantages include extending process utility to a wide variety of liquid flow streams that were not amenable to prior processes, as well as offering reactivating gas source flexibility and/or reducing significantly the required hydrogen use or reactivating gas for treating a given hydrocarbon feedstock. Significantly, the concepts disclosed herein afford substantial independence from other downstream refinery processing.

The instrumentalities disclosed herein pertain to method and apparatus for use in treating a liquid stream to remove impurities, where the impurities have a greater affinity for porous adsorbent particulates than do other components of the liquid. For example, a liquid flow stream passes upwardly through a first upright adsorber vessel that contains the porous adsorbent particulates. The flow rate is sufficient to establish fluidized bed performance between the porous adsorbent particulates and the liquid stream. The original fresh porous adsorbent particles comprise a narrow size range, such as 16 by 20 Tyler mesh, 20 by 24 Tyler mesh, and 24 by 28 Tyler mesh, within a preferred range of 16 to 45 Tyler mesh spherical solids range. Design of the fluidized bed under flow conditions that are anticipated in the intended environment of use permits fluidized bed expansion that is normally less than 10%. These design concepts prevent significant top to bottom mixing of the solids where the adsorbent bed is continuously replenished in each stage by entry of adsorbent at the top of the bed while withdrawal occurs from the bottom of the bed. Liquid phase fluidization is extremely smooth through the suggested bed expansion range.

The liquid flow stream in the adsorber vessel contacts the porous adsorbent particulates with sufficient overall residence time for impurity adsorbance to remove impurities in the liquid stream to produce both a purified liquid stream having a reduced impurity concentration and an impurity-bound adsorbent. The purified liquid stream is generally discharged from the terminal stage of the adsorber vessel as a treated product with excellent characteristics. For example, with FCC gasoline feedstocks, the adsorber treated product may be expected to be clear, colorless, free from objectionable odors, free from corrosive compounds such as mercaptans, and generally improved in octane quality. A variety of feedstocks including coker naptha with significant nitrogen, which were taken from actual refineries and processed through a pilot facility, had nitrogen contents for the adsorber treated product below 0.3 ppm and other content below 1 ppm. These advantages, in combination with subsequent sulfur removal, are useful in preparing feeds for downstream processing that economically benefits from such characteristics.

The impurity-bound adsorbent is withdrawn in a slurry from the first upright adsorber vessel and processed, e.g., by thermal processing, to regenerate the adsorbent for recycling purposes. The regenerated adsorbent is recycled through the adsorber vessel.

The first upright adsorber vessel is optionally but preferably constructed in a plurality of sequential adsorption stages in descending order from a terminal adsorption stage to a feed entry adsorption stage. Each of the adsorption stages is separated from the next descending adsorption stage by a flow distributor that permits upward flow of the liquid stream. The openings of the flow distributor are sized such that, when flow is stopped, the settled solids are prevented from proceeding to the next lower adsorption stager except through a transferal line that interconnects the respective stages. In this manner, the regenerated adsorbent first contacts the fluid having the lowest concentration of impurities and the heteroatoms accumulate.

The adsorbent that is withdrawn from the feed entry stage not only has fresh feed liquid filling the spaces between the adsorbent particles, but the porous adsorbent particles are filled with liquid. The slurry solids are separated from the liquids, for example, by a solid-liquid by a separator located atop the regenerator. Thus, the porous particles, free of most of the liquid form interparticle voids, are then subjected to regeneration. Part of the separated liquid may optionally be used, as needed, to decrease the density of the slurry in transit to the regenerator section, and the excess liquid is returned to the adsorber.

The porous solids withdrawn from the feed entry stage of the adsorber vessel have adsorbed liquids from the fresh feed liquid entering the adsorber vessel because the porous solids in an adequately regenerated slurry are introduced to the terminal adsorption stage and descend the full length of the adsorber vessel in contra-flow direction with respect to the flow of hydrocarbon liquid. The fresh feed liquid occupies interstices of the adsorbent particles, and impurities are more strongly attracted for adherence to the surface of the adsorbent particles than are the desired components of the treated liquid product. The term “impurity-bound adsorbent” is hereinafter used to describe this condition. For olefin hydrosorber feeds, olefins are adsorbed preferentially compared to the saturate present, and aromatics are preferentially adsorbed compared to the olefins. Thus, the process, when applied to FC feedstocks, facilitates recovering a significant portion of the desired liquid with the higher octane components, which are processed in the regenerator vessel and recycled to become part of the adsorbent-treated product.

These purposes are enhanced by creating flow conditions such that flow of the adsorbent particulates in each stage of the adsorber vessel is essentially plug flow in a fluidized bed state to minimize top to bottom mixing of the particulates. Each of the adsorption stages is configured for fluidized bed performance with less than about ten percent bed expansion in the respective fluidized beds within each adsorption stage. Accordingly, the porous adsorbent particulates flow through the first upright adsorber vessel downwardly in contra-direction to the liquid stream under conditions of the fluidized bed performance. The impurity-bound adsorbent is withdrawn from a bottom portion of each adsorption stage except for the feed entry adsorption stage and introduced into the next adsorption stage in descending vertical order. Adsorbent slurry from the fresh feed entry stage is similarly withdrawn and shipped to the regenerator vessel.

A nuclear density device in each of the adsorption stages is used to sense an upper level of the fluidized bed in each of the adsorption stage. A controller uses signals from the nuclear density device to control the position of the upper level by the action of flow valves to withdraw the impurity-bound adsorbent from each of the adsorption stages.

The regenerator vessel has at least a first desorption stage, a second desorption stage, and a cool-down stage. Thermal activity, e.g., from recirculated gas that is heated to a process adjusted temperature, in the first desorption stage normally heats to a lower temperature than is used in the second desorption stage and continuously volatilizes and desorbs a majority portion of purified liquid product from pores of the impurity-bound adsorbent to produce effluent-liquid vapor. The temperature in the first desorption stage is selected such that the vapor is primarily that of the desired treated feedstock. The effluent-liquid vapor from the first desorption stage is cooled to produce condensed liquid and the recycled gas. The temperature in the first adsorption stage is controlled for an economic level of impurities in the vapor effluent, such as approximately one-third of the sulfur concentration that is present in the fresh feed. The temperature in the second desorption stage is typically higher than that in the first desorption stage. Vapor effluent from the second regenerator stage is cooled to produce a heteroatom concentrate.

Solids leaving the first desorption stage are further heated using recycled gas to remove bound impurities and produce solid adsorbent particulates. The temperature in the second desorption stage is typically higher than that in the first desorption stage. Effluent from the second desorption stage contains the impurities. The regenerated adsorbent is cooled for subsequent use in the adsorber vessel.

Production of the recycled liquid to the adsorber may be performed in more than one desorption stage if a larger production scale units justify or require the capacity. It is preferred that gas flow to the final desorption zone to produce suitably regenerated particulate solids, which is readily permitted by the instrumentalities described herein. In the case of a regenerated solid adsorbent, this is preferably but optionally wetted prior to recycling through the adsorber vessel, in order to prevent the resultant heat of wetting from raising the temperature in the adsorber vessel. In this case, the adsorbent or the adsorbent slurry may be cooled sufficiently to overcome heat evolved from wetting the dried form of regenerated adsorbent.

Fresh original and makeup adsorbent more preferably contain at least 96 weight percent or greater of the porous adsorbent particulates in a range between 14 to 35 Tyler mesh size. A compatible small guard bed may be used to prevent non-regenerable poisons from entering with the fresh feed. A selective silicon adsorbing bed, for example, may be used to strip silicone from visbreaker liquids, which generally contain these compounds within feed naptha.

A preferred liquid flow stream, by way of example, may have a limited boiling range with more than 98 percent liquid present boiling below 250° C., so that economic pressure levels may be maintained in the regenerator vessel and to facilitate condensation of the product streams. Because lower temperatures favor adsorption, it is preferred to maintain the liquid flow stream entering the adsorber vessel at a temperature less than 40° C., or more preferably less than 20° C. This temperature is not necessarily required to reduce impurities down to even lower levels, but affords a lower solid circulation rate entering the regenerator section for regeneration processing.

The efficiency of impurity removal may be enhanced by varying the volume in the respective adsorber stages, for example, where the terminal adsorption stage has a settled bed height less than 30 meters, and the feed entry adsorption stage has a settled bed height less than four meters. This variation in the height of the respective stages is preferred because the adsorbent in descending adsorption stages has an increasingly higher concentration of impurities. The greatest amount of adsorption occurs in the first adsorption stage, which also contains adsorbent with the greatest amount of impurity. Higher stages have relatively lower impurity concentrations in the adsorbent and in the liquid undergoing treatment. It is preferred to limit the settled bed height in each adsorption stage to a height that is no more than twice the height of the preceding stage in descending order.

Regenerated adsorbent may be periodically withdrawn and screened to remove fines. Selected sizes of the screened fines may be used to filter the liquid fresh feed if the liquid fresh feed contains scale, other possible debris, or non-regenerable poisons.

When these instrumentalities are implemented, impurities may be reduced with lower utility costs to levels that were not practically obtainable in the prior art.

An especially preferred feature of the regenerator vessel is the use of a gas flow distributor or distributors each including a thin cross-flow bed having a thickness less than about 0.5 meters. The adsorbent solids pass downwardly at a gentle rate while being subjected to cross-flow gas heating with hot gas entering the solids after passing through the distributor. Effluent vapors are discharged from the adsorbent, and these vapors are condensed and collected downstream of the regenerator vessel for subsequent use. The distributors retain the solids but permit passage of the hot gasses, as well as su8bsequent lower temperature gasses that are used to cool the hot solids.

Although admirably suitable for processing olefinic hydrocarbon feedstocks, the method and apparatus according to the principles described herein can be applied to numerous other feed applications, such as chemicals, where a suitable adsorbent has a selective affinity for the impurities and the feedstock has a limited boiling range suitable for regeneration. Impurities from the liquid stream are concentrated according to these principles, and may have an increased commercial value in concentrated form.

In the case of treating a fluid catalytic cracker (FCC) full boiling range gasoline feedstock, these principles advantageously disclose returning to the fresh feed stream most of the desired hydrocarbon that is taken from the solids entering the regenerator vessel. Olefins are preferentially returned together with a significant amount of aromatics. The impurity byproduct, which is a heteroatom concentrate in the case of hydrocarbon feeds, is reduced to a volume that reflects the adsorbed impurities. The high octane components are adsorbed preferentially over lower octane saturates in the pores of the adsorbent, but these materials are recycled to the liquid stream after regeneration of the adsorbent. Selective removal of these materials is facilitated by the fact that they have a different affinity for the adsorbent than either the low octane components or the impurities. For example, most of the olefins are returned from the regenerator to the adsorber vessel to become part of the adsorber treated product. The return of these materials reduces significantly the chemical hydrogen demand if hydrotreating s used for removing the heteroatoms from the heteroatom concentrate. The high octane materials derived from the regenerator vessel have a significant C8 and higher mono aromatic content.

The treated product according to the instrumentalities disclosed herein is, therefore, higher in quality and yield, despite the use in prior processes of higher solid circulations rates with lower flow rates of hydrocarbon liquids to achieve lower sulfur concentrations, such as a 5 ppm by weight concentration of sulfur that is desired by automotive manufacturers.

### BRIEF DESCRIPTION OF THE DRAWINGS

FIG. 1 is a process schematic diagram illustrating method and apparatus for use in an adsorber/regenerator facility according to the principles and instrumentalities described herein;

FIG. 2 is a generalized graph demonstrating principles of fluidized bed operation involving pressure differential and fluid velocity;

FIG. 3 depicts a section of an adsorber vessel implementing the principles disclosed in the context of FIG. 2;

FIG. 4 is a top midsectional view of a regenerator vessel and depicts a thin crossflow bed within the regenerator vessel; and

FIG. 5 shows a compression system for using recycled gas to cool adsorbent within the regenerator vessel.

### DETAILED DESCRIPTION

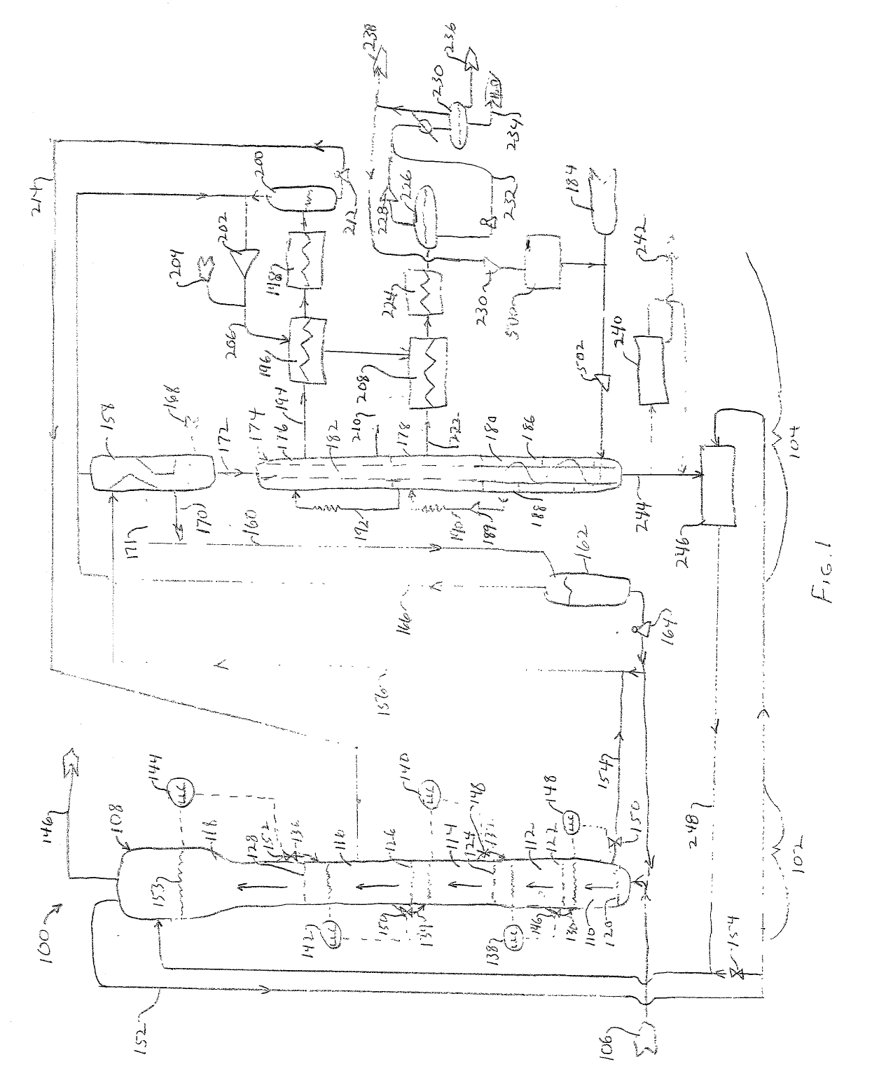

FIG. 1 is a process flow diagram illustrating a facility 100 that contains significant improvements over the system shown and described in U.S. Pat. No. 5,730,860.

Adsorber Section

An adsorber section 102 is used to remove impurities from liquids, such as hydrocarbon liquids, where these impurities have a preferential affinity for an adsorbent in respect to the affinity of a desired component for the adsorbent. A regenerator section 104 is used to remove the impurities from the adsorbent and to process the adsorbent for recycling through the adsorber section 102. In addition to hydrocarbon liquid feedstreams, other liquids may be used, provided that the impurities in the feed stream have a preferential affinity for a solid adsorbent over the desired components. The following is simplified to show, by way of example, the use of a hydrocarbon fresh feed.

A hydrocarbon fresh feed 106, which is suitably cooled and free of agents which might unduly impair the performance of the adsorbent over long term use, enters an adsorber vessel 108 through a fresh feed entry stage 110. The fresh feed entry stage 110 is serially followed by a second adsorption stage 112, a third adsorption stage 114, a fourth adsorption stage 116, and a terminal adsorption stage 118. The precise number of adsorption stages is related to the type of adsorbent that is used, the concentration of impurities in the fresh feed 106, and the objective level of impurity reduction. Each of the adsorption stages 110-118 is a completely filled upright fluidized bed containing hydrocarbon liquid and adsorbent particles. Each of the adsorption stages 110-118 contains a corresponding lower inlet 120. 122, 124, 126, and 128, which each comprise a flow distributor, such as a Johnson-type screen or porous plate that permits the passage of liquid and gas while retaining the adsorbent particles. Any number of adsorption stages may be used. The respective adsorption stages may have different settled adsorbent bed thicknesses lengths that, for example, optionally but preferably increase in ascending order. For example, the preferred settled bed height of adsorbent in the feed entry stage 110 is less than four meters. The preferred settled bed height in the terminal adsorption stage 118 is less than 30 meters.

Inter-stage adsorbent transfer lines 130, 132, 134, and 136 permit the downward flow of adsorbent in serial order between the respective adsorbent stages 110-118. Thus, adsorbent in the fourth adsorption stage 116 has a higher concentration of impurities than does the adsorbent in the terminal adsorption stage 118 because the adsorbent in the fourth adsorption stage 116 is transferred from the terminal adsorption stage 118. Similarly, the adsorbent in the third adsorption stage 114 has a higher concentration of impurities than does the adsorbent in the fourth adsorbent stage 116, and the adsorbed impurity concentration increases with descent until the fresh feed adsorption stage 110 has the highest impurity concentration of all. Descending solid adsorbent slurry flow between the adsorption stages 110-118 through the inter-stage transfer lines 130-136 is regulated for each stage by a corresponding solid interface level controller 138, 140, 142, or 144, which governs the opening of a corresponding flow valve 146, 148, 150, or 152, which are preferably pinch valves. This control may be accomplished, for example, by using nuclear density gauges to sense the upper particulate adsorbent levels, such as level 153, in each of the fluidized beds within adsorption stages 110-118 and adjusting the opening of flow valves 146-152 to maintain this interface within a predetermined level. The pressure differential that is available to overcome distributor bed friction loss and flow valve loss on downflow of the adsorbent is offset by the heavier slurry density of the adsorbent versus the clear liquid in each of the adsorber stages 110-118 above the solid-liquid interface because the fluidized solids behave like heavy liquids in adding hydrostatic head.

Treated hydrocarbon liquid exits the adsorber vessel 108 through line 146, which may, for example, be treated gasoline or a treated feedstock for downstream processing. A final liquid level controller 148 adjusts valve 150 to provide a dense slurry adsorbent withdrawal line 154 that feeds the regeneration section 104. A second exit line 148 leaves the terminal adsorption stage 118 to supply fluid for cooling and to assist slurry transport in the regenerator section 104. Valve 154 may be opened to recirculate hydrocarbon liquid through the adsorber vessel 108.

The hydrocarbon fresh feed 106 contains impurities having a special affinity for the adsorbent in adsorber vessel 108. The hydrocarbon feed impurities may include, for example, hydrocarbons such as those containing nitrogen, oxygen and sulfur in the form of heteroatoms or other non-heterocyclic compounds. Sulfur-containing compounds, include, for example, mercaptans, sulfides, disulfides, thiophenes, and benzothiophenes. Nitrogen containing compounds include, for example, nitriles and pyridines. Oxygen-containing compounds include, for example, alcohols, ketones, ethers, and esters. The impurities that are especially susceptible to adsorbent removal include impurities having a polar atom which facilitates preferential adsorption. The terms “heteroatom,” “heteroatom liquid” and heteroatom concentrate” are all hereby defined as including the materials described above.

The adsorbent in each of the adsorbent stages 110-118 is preferably a particulate adsorbent comprised of alumina and zeoloites, however, any selective adsorbent may be used where the impurities and the desired treated liquid product have different affinites for the adsorbent. For use with dirty feeds, such as coker naptha feeds, a relatively small guard bed filled with a selective adsorbent may be used to remove the non-regenerable silicon compounds and prevent them from interfering with long term performance of the recirculating adsorbent. For hydrocarbon feed service, the adsorbent particles are, in a preferred sense, generally spherical in the original or new adsorbent, with a narrow size range such as 16×20, or 20×24 Tyler mesh.

Liquid phase adsorption differs from gas phase adsorption in that diffusion is at least two orders of magnitude slower in the liquid phase than in the gas phase. Diffusion of components in a liquid phase requires additional residence time, which is why adsorber vessel 108 is constructed in a series of adsorption stages 110-118. Impurities adsorb on the solid adsorbent because the attraction of the adsorbent surface is stronger than the attractive force that keeps the impurities in the surrounding fluid. Liquid adsorption may be defined as a type of adhesion that, in a thermodynamically preferred sense, occurs at the surface of a solid having an adsorbable impurity in the liquid medium. This preference results in a relatively increased concentration of adsorbable impurities entering the adsorbent particle pores. Solid porous particles can exhibit attraction for impurities for a number of reasons, such as physisorption or chemisorption. Physisorption is due to physical attraction or Van der Waal's forces. Chemisorption is that due to chemical or valence forces.

Adsorption is accompanied by evolution of heat because the adsorbate molecules are stabilized on the adsorbent surface. For limited quantities of impurities in the fresh feed, temperature increase of the fluid is limited by the amount of adsorbable impurities that are typically present, i.e. the sensible heat of the other liquid components offsets the heat evolution due to impurities. Therefore, the temperature rise in the adsorber generally is only several degrees Fahrenheit.

Smaller particulates present additional surface area at the fluid-solid interface for adsorption. If not limited by the process that is used to manufacture the adsorbent, smaller adsorbent particles can advantageously be used in the fluidized adsorbent stages 110-118 that are shown in FIG. 1. This improvement is made possible in fluidized beds because these beds substantially eliminate the pressure drop and crushing concerns that arise when using smaller particles in fixed downflow static bed adsorbers. These smaller particulates may need to be produced on commercial order that specifies the size range as defined herein.

Smaller adsorbent particles advantageously enhance the heat transfer and mass transfer for a given gas at otherwise constant conditions. Smaller particles are more difficult to break than larger particles because smaller particles tend to have fewer faults, flaws or discontinuities. Porous particles of a given size are more resilient than non-porous particles of similar size and less prone to fracture.

A disadvantage of smaller particles is that a smaller cross section flow is required for otherwise constant conditions, such as type of liquid feed, inlet temperature, adsorbent replenishment rate, and liquid feed rate, is required to obtain the same fluidized bed height, which increases the adsorber diameter for a given bed expansion and liquid feed rate under fluidized conditions. This requirement is offset by the fact that a larger diameter provides a larger adsorbent inventory for a given bed height. Higher bed expansions can help offset this disadvantage of smaller particles, but the bed expansion is limited by a need to provide plug flow-like behavior within a fluidized stage. As described below, an undesirable turbulent top to bottom mixing occurs when bed expansions increases sufficiently.

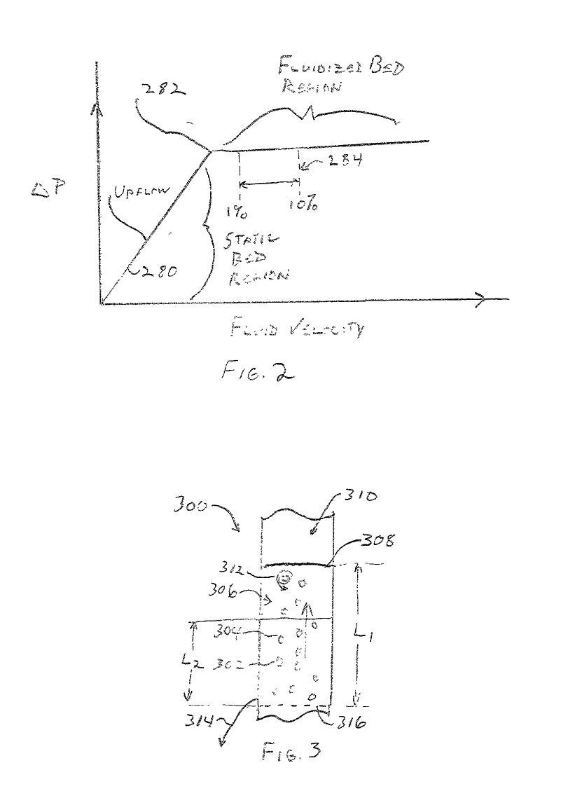

FIG. 2 depicts the principles of fluidized be operation as they pertain to general relationships between fluid velocity and pressure drop across the bed. Pressure drop increases with increasing flow velocity along line 280 until particulates in the bed are being lifted by the flow at a point 282 of minimum fluidization. Pressure drop thereafter over a fluidized bed region of flow is largely constant and only slightly increases with increasing flow velocity. As shown in FIG. 3, stage 300, which represents any one of adsorbent stages 110-118, the adsorbent particulates, e.g., particulates 302 and 304, are suspended in the flow of hydrocarbon liquid 306. The particulates do not rise past an interface 308 defining the upper limit of the fluidized bed along length L₁. Region 310 above interface 308 is a clear liquid. The length L₁ varies depending upon the viscosity of the hydrocarbon liquid 306, the flow rate, the particulate diameter, and the densities of the hydrocarbon liquid and the adsorbent particulates. If flow were to cease or fall below point 282 of minimum fluidization, as shown in Fig,. 2, the particulates 302 and 304 would collapse to a static bed at length L₂. Bed expansion may be calculated by equation (1):

E=(L₁−L₂)/L₂ (1)

where E is bed expansion expressed as a fraction, and L₁ and L₂ are defined above in reference to FIG. 3 as the static (L₁) and fluidized (L₂) bed lengths.

It has been discovered that flow conditions which produce bed expansions ranging from 1% to 10% provide a highly desirable plug flow-like behavior in the fluidized bed because the particles exhibit local circulatory motion in the manner of pattern 312, as opposed to top to bottom mixing in turbulent conditions. After the initial rise of the particles, any introduced particles gradually descend in a local circulatory pattern against the flow towards a bottom discharge 314, which is located at a liquid inlet distributor 316 for removal of particulates. The term “plug flow-like behavior” is not a true unidirectional plug flow, but is used herein to indicate that individual particles tend to migrate upward and downward together as a group that occupies the same level, despite the fact that the flow of liquid proceeds in a uniformly upward direction contrary to the downward flow of particulates. Less than 1% bed expansion is required to initiate fluidized performance. More than 10% bed expansion results in top to bottom circulation that is too rapid with resultant lowering of concentration differences and increase of utilities in the regenerator section 104.

One advantage of a fluidized adsorption stage is that a longer bed is unaffected by possible bed crushing strength concerns that, otherwise, arise in context of a downflow fixed bed adsorber. With careful attention of adsorbent addition at the top of a stage and withdrawal at the bottom of a stage, limited bed expansion does not cause undue deviation from plug flow behavior. Solids are withdrawn at the bottom distributor as a dense slurry for transfer to another stage or as spent adsorbent from the feed entry stage. Significantly fewer stages can be used by having the smallest height of bed at the feed entry stage 110 with greater bed heights for the latter stages 112-118. Lower bed height minimizes the fluidized bed behavior because the impurity concentration difference occurring in a bed decreases. The bed in feed entry stage 110 introduces the fresh feed 106 at the point of highest impurity concentration in the adsorbent, which has the highest impurity concentration when withdrawn through line 154 for regeneration

Reducing the number of fluidized stages in an adsorber vessel of a given height greatly enhances the adsorber inventory that may be stored in a vessel of fixed diameter, as shown in the following Table 1. Such reduction also reduces the costs of associated instrumentation and flow control devices that are required for each stage. For example, the cost of a nuclear density gage, which detects the fluidized solids-liquid interface 308 at the top of a fluidized stage to assist in controlling the bed height within each fluidized stage, is of the order of $15,000. By using longer settled bed height in a stage, more adsorbent inventory can be stored in a given adsorber vessel. Table 1 illustrates the dramatic increase in adsorber efficiency by using greater settled bed heights. The adsorber inventories can be increased by a factor of more than two, with not much greater overall capital investment and a significant reduction in utilities, both of which relate to the rate of solids entering the regenerator for a given feed.

TABLE 1
ILLUSTRATIVE EFFECT OF INCREASED BED HEIGHT UPON
ADSORBER, VOLUMETRIC EFFICIENCY

| Example | Base | A | B | C | D | E | F |
|---|---|---|---|---|---|---|---|
| Settled solid bed | 10 | 20 | 30 | 40 | 50 | 60 | 80 |
| height, ft. | | | | | | | |
| Design bed expansion | 1 | 2 | 3 | 4 | 5 | 6 | 8 |
| at 10%, ft. | | | | | | | |
| Constant transfer | 5 | 5 | 5 | 5 | 5 | 5 | 5 |
| height allowed above | | | | | | | |
| expanded bed, ft. | 5 | 5 | 5 | 5 | 5 | 5 | 5 |
| Overall stage height | 16 | 27 | 38 | 49 | 60 | 71 | 93 |
| Adsorber volumetric | .625 | .741 | .789 | .808 | .833 | .845 | .860 |
| efficiency | | | | | | | |

Adsorber volumetric efficiency is defined as the volume of adsorbent in a settled bed divided into the total volume in an adsorber stage. For a cylindrical vessel, assuming constant adsorber diameter, this ratio is equivalent to overall stage height divided into the settled bed height. An expanded diameter, such as at the top of the terminal adsorption stage 118 can increase the adsorber inventory for a given height, accommodate the hydrocarbon recycle liquid entering the stage (e.g., as through line 214), and accept the additional volume of regenerated adsorbent slurry (e.g., through line 152) for transport. Optimum adsorbent size and residence time for a particular adsorbent is a matter for empirical study under actual process conditions Use of a greater adsorber inventory facilitates correspondingly greater capacity for impurities to deposit on the adsorbent particles.

It is possible to use more than one adsorber vessels in series. For example, the exit line 146, shown in FIG. 1, may be used as a fresh feed source 106 to feed an optional second adsorber vessel (not shown. In this case, liquid from the top of the adsorber vessel 108 reduces the required pumping head. Similarly, the adsorbent withdrawal line 154 may be used to feed adsorbent to the top of the second adsorber vessel.

For otherwise constant conditions, a cooler adsorber vessel 108 results in a lower impurity content in the adsorber treated product. The heat of wetting a dry adsorbent is surprisingly appreciable, and it is preferred to introduce the regenerated adsorbent continuously as a precooled slurry rather than dry solids. Furthermore, the use of liquids for slurrying provides a liquid film that protects the adsorbent particles from mechanical degradation during transport. The use of a cooled slurry facilitates lower impurity content in the treated product by avoiding an increased temperature transient due to the heat evolution from wetting dried adsorbent. A reduction in the amount of solids circulated to the regenerator section 104 is generally obtained, for example, by maintaining the fresh feed 106 at a temperature below ambient, because the lower temperature improves the adsorption capacity of the adsorbent, as well as lowering the sulfur content of the adsorber treated product for other wise constant conditions when using a hydrocabon liquid having a naptha boiling point range.

Costs to build the adsorption section 102 are less than one-third of costs to build the regeneration section 104. Increased adsorbent inventory for otherwise constant conditions, such as use of the same liquid feedstocks, fresh feed rate, adsorber inlet temperature, regeneration conditions, and sulfur content of the treated liquid, in practice increases the impurity concentration deposited on the spent adsorbent that is withdrawn from the feed entry stage 1 10. The capital cost of the regenerator section 104 is decreased by the instrumentalities disclosed herein because capital require3ments are reduced correspondingly with a reduction in the solid circulation rate that must be processed through the regenerator section 104. Operating cost for utilities is primarily associated with the regeneration section 104. Reactivating gas circulation includes the make-up gas from gas sources 184 and 204, in a volume that is also related to the solids circulation rate through the regenerator section 104.

Regenerator Section

As shown in FIG. 1, regenerator section 104 comprises fewer equipment items including heat exchangers and gas compressors, in comparison to the desorber vessel shown in U.S. Pat. No. 5,730,860.

The adsorbent withdrawal line 154 feeds dense adsorber slurry with bound impurities to a dilute slurry transport line 156, which discharges into a liquid-solid separator 158. The liquid-solid separator 158, as shown in FIG. 1, illustrates a plurality of screens that separate the adsorbent particulates from the hydrocarbon feed liquid that fills the void spaces between the solid adsorbent particles. Separated liquids exit the liquid-solid separator 158 into a drained liquid line 160, which discharges into a liquid surge vessel 162. Part of the liquid from surge vessel 162 may be used as a lift medium to lower the density of the slurry flowing through line 156. Pump-assisted line 164 is optionally provided for this purpose so that the vertical lift medium is pumped as a liquid without solids using the liquid both as a diluent and a transport medium. The additional of liquid for use in such transport through line 156 minimizes attrition of the solid adsorbent particles because a liquid film cushions the particles from impact with other particles and corresponding mechanical degradation of the solid adsorbent particles. Line 166 is a gas pressure equalization line. A solid adsorbent feed 168 supplies additional adsorbent, as needed.

Liquids leave the solid-liquid separator 158 through lines 170 and 171. Separated adsorbent solids exit the solid-liquid separator 158 through line 172 to enter a regenerator vessel 174, preferably by gravity. The solids therein are subjected to heated cross flow for heating of the descending solids and regeneration of the adsorbent. Regenerator vessel 174 includes a first desorption zone 176, a second desorption zone 178, and a cool-down zone 180. A central flow distributor 182 contains openings that are small enough to retain solids while permitting gas to flow. The solids gradually descend the length of the central flow distributor 182 subject to thermal processing in the form of cross flow heating for desorption purposes, as well as subsequent cooling through a number of cross flow zones.

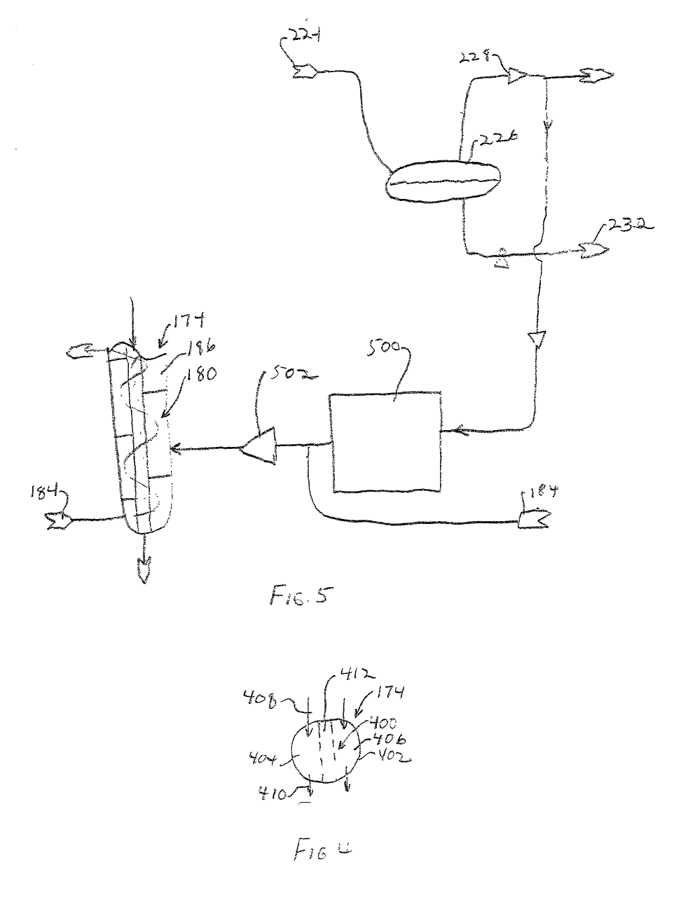

FIG. 4 provides a top midsectional view of the regenerator vessel 174. The central flow distributor 182 contains one or more thin cross flow beds 400, preferably having a thickness less than about 0.5 meters. Multiple beds (not shown), such as cross flow bed 400, may exist in the central flow distributor 182. An exterior wall 402 defines respective heating cavities 404 and 406 that each accept heating gas 408 and discharge a mixture 410 of heating gas and volatilized liquid from the adsorbent. Cavities 404 and 406 may be baffled to enhance heat exchange. Thin cross-flow beds, such as bed 400, are used in the regenerator vessel 174 to minimize readsorption effects, otherwise, occurring when the desorbing gas flow path is too long. The thinness of the cross-flow beds also minimizes residence times for the adsorbent in the high temperature portions of the central flow distributor 182 where the adsorbent is potentially subjected to coking temperatures. Smaller adsorbent particles also enhance the heat and mass transfer for a given gas at otherwise constant conditions.

A gas source 184 is preferably a hydrogen-containing gas source, nitrogen, or any other gas that is free of any material which would interfere with the adsorptive qualities of the regenerated adsorbent. The gas source 184 provides supplemental gas, as needed, to the cool-down zone 180. A plurality of cool-down cross flow stages, such as stages 186 and 188, facilitate a temperature reduction in the regenerated adsorbent that approximates or approaches the temperature of solids leaving the adsorber section 102 through line 154. The hot gas from cooling stage 180 is compressed by compressor 189 to enter a first heater 190 that supplies gas to the second desorption stage 178. This gas is heated, for example, to approximately 30° F. above the temperature of solids leaving the first desorption stage 176. Hot gas from the second desorption stage 178 is, in turn, supplied to a second heater 192, which assures that the gas is heated to a temperature sufficient to volatilize the liquid hydrocarbon without substantial loss of adsorbent-bound impurities through the first desorption stage 176. The temperature in the first desorption zone 176 is typically 530° to 570° for volatilization of these liquids depending upon the composition of the hydrocarbon liquid.

As will be explained in more detail below, effluent gas from the second desorption stage 178 preferably provides by heat exchange part of the heat that is required for the recirculated gasses entering the first desorption stage 176. For hydrocarbon feeds, further cooling of the effluent vapor occurs with condensation of the heteroatom condensate forming a liquid that may be separated from the remainder of the effluent vapor. The remaining effluent vapor stream is further compressed, recontacted with the liquid heteroatom concentrate, and subjected to additional separation at low temperature to condense even more liquid, including water. The remaining gas may be passed through a solid bed device, preferably using zeolites, to remove any remaining trace impurities from the from the remaining gas, which is then recycled through the regenerator vessel 174. Thus, the recycled gas requires minimal make-up volume. and minimal net heat loss is incurred through the cycle.

Hydrogen possesses a significantly higher heat conductivity and a lower viscosity than most gaseous fluids at otherwise constant conditions. A hydrogen-containing gas source 184, therefore, is preferably introduced as make-up gas to the first desorber stage 176 at a fraction of the gas quantity that enters the cool-down zone 180, although, other compatible gasses may also be used. Provision of this hydrogen containing gas to the first adsorber stage 176 assures sufficient hydrogen to saturate the thermally unstable components which might be formed at higher temperatures when another makeup gas, such as nitrogen sufficiently free from impurities is also used as makeup to the cool-down stage 180. A limited amount of a hydrogen-containing gas totaling less than 10 percent of the reactivating gas to the cool-down stage 180 may be drawn from the hydrogen-containing gas source 184, while nitrogen or other suitable gas may comprise the remaining volume.

The purpose of the first desorption zone 176 is to remove most of the desired hydrocarbon liquids in the pores of the solid adsorbent particulates. Recirculated gas enters the first desorption stage 176 after being heated by the first heater 192 to a temperature of about 400° F. in the caser of a hydrocarbon naptha feedstock, or any other temperature sufficient to accomplish this purpose depending upon the feed composition. The effluent containing the vaporized liquid exits through line 194 and is preferably heat exchanged in heat exchanger 196 using compressed recirculated gas from compressor 202. This gas is preferably derived from the effluent, but may be supplemented using make-up volumes from gas source 204, which may contain hydrogen, nitrogen, or another compatible gas. The effluent from heat exchanger 196 is further cooled to about 40° using a cooler 198, and separated in gas-liquid separator 200, with the condensed liquid recycle returned to the adsorber vessel 108 through pump 212 and line 214. Gas source 204 provides a comparatively small makeup gas volume that approximates 10% of the gas volume entering the second desorption stage 178. The gas source 214 preferably contains sufficient hydrogen to ensure that a hydrogen-containing atmosphere exists in the regenerator vessel 174.

The composition of fluid condensate evolved after cooling the vapor effluent varies with the temperature of solid adsorbent leaving the first desorber stage 176. The impurity content of the condensate evolved increases with temperature of the solids, but as the hydrocarbon liquid recycle is subject to cleanup in the adsorber vessel 108, is desirable to have about one-third of the impurities removed in the first desorber stage 176. Readily adsorbed components like nitrogen compounds and peroxides in the fresh feed are practically absent, e.g., at concentrations of less than 2 ppm by weight, from the recycle as long as temperature leaving the first desorber stage 176 is less than about 380° F. in the case of an olefinic full boiling range FCC feedstock approximating a nitrogen-compound impurity concentration of 60 ppm in the fresh feed. This circumstance affords additional economies by injecting, through use of pump 212 and line 214, the condensed liquid recovered from gas-liquid separator 200 into the latter stages of the adsorber vessel 108 to improve the yield and quality of the adsorber treated product in the case of a FCC gasoline feedstock.

As described above, adsorbed impurities from the regenerator section 104 are concentrated in a liquid recycling system using line 214 to return most of the desired components to the adsorber section 102 where the recycled liquids become part of the adsorber treated product. Liquid from the fresh feed fills the spent adsorbent pores with a different composition of which impurity components are only part. In an olefenic fresh feed example, most of the olefins in the spent catalyst pores are returned in the liquid recycle from the first desorption stage to the latter stage of the adsorption section 102. Olefins in the heteroatom concentrate are reduced with subsequent hydrogen consumption advantage, if hydrogenated. The concentrated impurity liquid has relatively low olefin content as a result of the process shown.

It is also possible, using hydrogen for all makeup gases in the regenerator, to have the final desorption zone effluent gas containing the heteroatoms directly enter a gas phase reactor with the heat exchange and cooling occurring after proceeding through the reactor.

The second desorber stage 178 desorbs higher boiling point aromatics together with the impurities. The second desorber 178 has a solids outlet temperature that is significantly higher than that of the first desorber stage 176. This temperature is about 540° F. to 570° F. in the case of a full boiling range FCC feedstock. A greater temperature is normally required to volatilize and liberate the impurities from the adsorbent because some impurities are chemisorbed, as opposed to liberating the pore-bound hydrocarbon liquid in the first desorber stage 176. Effluent vapors from the second desorber stage 178 are transferred through line 222, into the second heat exchanger 208, and into a second cooler 224 that condenses the vapors to a mixed quality liquid-vapor state. The flow discharges into a second gravity separator 226 from which a gas output is disposed through compressor 228 to a recontact cooler 230. A heteroatom concentrate is also disposed from gas-liquid separator 226 to the recontact cooler 230 through pump assisted line 232. The recontact cooler 230 separates water for disposal through line 234, heteroatom liquid concentrate through line 236, and gas effluent through line 238. The heteroatom concentrated liquid output through line 236 in the case of FCC gasoline feedstocks is usually disposed of to an existing hydroprocessor for disposal of the heteroatoms, but because of the decreased volume, other disposal techniques such as biological processing are made economically feasible by the instrumentalities described herein.

As shown in FIG. 5, the required volume of makeup gas that is supplied to the cool-down zone 186 from gas source 184 is reduced by to less than 3% of the volume that was used in prior processes through use of an adsorption bed 500 and using a compressor 502 to compress the gas from gas-liquid separator 226 Gas make-up from gas source 186 may be 9introduced upstream or downstream of the compressor 502. The recycled gas in the case of a full boiling range FCC feedstock normally supplies at least about 97% of the total gas volume that is needed for use in the final desorption stage 178. The makeup that is required from gas source 184 is only to replace losses from leakage, gas that is lost to liquid condensation, and possible solution gas losses in the liquid leaving the regenerator section 104. The recycled gas supplies most of the gas needed with only a net makeup required from gas source 184. The recycling of gas permits flexibility to use additional and more economic gas sources as gas source 184. For example, nitrogen gas may be used for net make-up volume, as well as hydrogen chloride-free vent gasses.

In operations involving a typical hydrocarbon feedstock, gas that is recycled through adsorption bed 500 provides about 97% of the gas entering compressor 502. Accordingly, heat exchangers 196, 208, as well as coolers 198, 224, recover most of the heat expenditure without having a large thermal loss in heating make-up gas from gas source 184. Solids leaving the second desorption stage 178 usually have a temperature ranging from 540° F. to 570° F., and the gas entering cooling stage 180 cools these solids to about 110° F., in a typical hydrocarbon feedstock operation. Because only small volumes of gas are required from gas source 184 and the purge volume exiting line 238 is also small, acceptable gas sources 184 may include such facilities as the hydrogen-containing vent (not shown) of an isomerization unit, with similar hydrogen chloride removal as for when a small part of the catalytic reformer gas hydrogen byproduct is used for makeup gas.

Chilling of the first desorption zone effluent before it enters the gas-liquid separator 200 is desirable depending upon the feed to lower the concentration of any of the more volatile desired components in the recirculated gas. The recirculated gas for the first desorption zone from the gas-liquid separator, as shown in FIG. 3, is compressed for heat exchange and heating sufficiently to heat the descending particles in the first desorption zone to a given temperature. In hydrocarbon feeds, limited amounts of the strongly adsorbed, less volatile impurities, are observed in the condensate recovered from the gas-liquid separator 200. The volume of heteroatom concentrate discharged through line 236 is also small, integration of a facility 100 producing these impurities into a particular existing refinery is more easily feasible. The reduce volume and limited olefin content of the concentrated heteroatom liquid that is discharged on line 236 facilitates alternative means of desulfurization, such as biological processing.

A screening device 240 is periodically used on long term basis to separate fines from the solid regenerated adsorbent exiting the regenerator vessel 174. The screening device 240 prevents excessive fines in the adsorbent. Periodic screening is performed top remove fines because particles may be expected to attrite in the regenerator section 104 due to mechanical abrasion, thermally induced forces, gas cross flow forces, and particle collisions. The fines are disposed through a fine waste line 242. An intermediate size can be used and may optionally be screened for filling of adsorption bed 500 on a long term periodic basis. The fines may also be used to filter the fresh feed 106 for removal of scale and other possible debris, as well as preventing non-regenerable from contaminating the circulating solid adsorbent.

Regenerated adsorbent exits the regenerator vessel 174 through line 244 to enter a slurrying station 246. The purpose of slurrying station 246 is to wet the dried using treated hydrocarbon liquid from the adsorber vessel 108. Line 152 supplies the slurrying station 246 with treated hydrocarbon liquid for this purpose. Slurrying station 246 accomplishes the objective of wetting the dried adsorbent to evolve heat of wetting outside the adsorber vessel 108. The resultant slurry, which is preferably cooled to the temperature of fresh feed 106 entering the adsorber vessel 108, is amenable to transportation through line 248 for delivery to the terminal adsorption stage 118. The slurry delivered to the adsorber vessel 108, accordingly, descends through the respective adsorption stages 110-118 in contra-flow direction compared to the ascending flow of fresh feed 106.

Capital investment in the regenerator section 104 is driven by the solid circulation rate entering the regenerator vessel 174. Increasing the adsorber inventory can, therefore, enhance the overall capital investment and is compatible with lower sulfur content transportation fuels desired by automobile manufacturers because of lower capital for the regenerator section 104, particularly with a simplified adsorber and regenerator section, as is illustrated by the attached figures. Operating costs for utilities are primarily associated with the duty on the regenerator section 104.

The foregoing discussion is intended to illustrate the concepts of the invention by way of example with emphasis upon the preferred embodiments and instrumentalities. Accordingly, the disclosed embodiments and instrumentalities are not exhaustive of all options or mannerisms for practicing the disclosed principles of the invention. The inventor hereby states his intention to rely upon the Doctrine of Equivalents in protecting the full scope and spirit of the invention.

I claim:

1. A method of treating a liquid stream to remove impurities, where the impurities have a greater affinity for porous adsorbent particulates than do the components in the liquid, the method comprising the steps of:
(a) flowing the liquid stream upwardly through a first upright adsorber vessel that contains the porous adsorbent particulates at a flow rate sufficient to establish fluidized bed performance between the porous adsorbent particulates and the liquid stream, the porous adsorbent particulates comprised of a 8 to 48 Tyler mesh range with a size distribution that permits bed expansion no greater than 10 percent;
(b) contacting the liquid stream with the porous adsorbent particulates during the performance of step (a) with sufficient residence time for impurity adsorbance that removes impurities in the liquid stream to produce both a purified liquid stream that has a reduced impurity concentration and an impurity-bound adsorbent;
(c) discharging the purified liquid stream from the adsorber vessel;
(d) withdrawing the impurity-bound adsorbent in a slurry from the first upright adsorber vessel;
(e) processing the impurity-bound adsorbent from step (d) to remove impurities therefrom and produce a regenerated adsorbent; and
(f) recycling at least a portion of the regenerated adsorbent through the adsorber vessel.

2. The method according to claim 1, wherein the first upright adsorber vessel is constructed in a plurality of sequential adsorption stages in descending order from a terminal adsorption stage to a feed entry adsorption stage, each of the adsorption stages separated from the next descending adsorption stage by a flow distributor that permits upward flow of the liquid stream while retaining the porous adsorbent particulates that settle atop the flow distributor under gravitational influence, each of the adsorption stages configured for fluidized bed performance according to conditions defined in the flowing step (a), and the flowing step (a) further comprises:
(g) flowing the porous adsorbent particulates through the first upright adsorber vessel downwardly in contra-direction to the liquid stream under conditions of the fluidized bed performance;
(h) removing the impurity-bound adsorbent from a bottom portion of each adsorber stage except for the feed entry adsorption stage; and
(i) introducing the impurity-bound adsorbent removed in from each adsorption stage in step (h) into the next adsorption stage in descending vertical order.

3. The method according to claim 2, wherein the withdrawing step (d) is accomplished by (j) withdrawing the impurity-bound adsorbent from a lower portion of the feed entry adsorption stage.

4. The method according to claim 2, wherein the withdrawing step (d) is further accomplished by (j) sensing an upper level of the fluidized bed in each of the adsorption stage by the action of a nuclear density device and (k) controlling the position of the upper level by the action of flow valves to withdraw the impurity-bound adsorbent from each of the adsorption stages.

5. The method according to claim 1, wherein the processing step (e) comprises
(g) transporting the impurity-bound adsorbent from the withdrawing step (d) to a liquid-solid separator that separates liquids from the slurry; and
(h) returning the liquid from step (g) to the adsorber vessel.

6. The method according to claim 5, wherein the processing step (e) further comprises
(i) transporting solids from the liquid-solid separator to a regenerator vessel that completes the processing step (e).

7. The method according to claim 1, wherein the processing step (e) comprises:
(g) transporting the impurity-bound adsorbent to a regenerator vessel having at least a first desorption stage, a second desorption stage, and a cool-down stage for regeneration of the impurity-bound adsorbent,
(h) using thermal activity in the first desorption stage to continuously volatilize and desorb a majority portion of purified liquid product from pores of the impurity-bound adsorbent to produce effluent-liquid vapor;
(i) after step (h), desorbing impurities in from the impurity-bound adsorbent by increased thermal activity in the second adsorption stage to produce the regenerated adsorbent and effluent-impurity vapor; and
(j) after step (i), cooling the regenerated adsorbent for use in the recycling step (f).

8. The method according to claim 7, comprising (k) cooling the effluent-liquid vapor from the using step (h) to produce condensed liquid and associated gas.

9. The method according to claim 8, including (l) combining the condensed liquid from the cooling step (k) with the liquid stream for use in step (a).

10. The method according to claim 9, including a step (m) of hydrogenating the condensed liquid prior to step (l).

11. The method according to claim 7, wherein the desorbing step (i) comprises
(k) heating a gas supply and contacting the impurity-bound adsorbent with the same to provide the thermal activity in the second desorption stage.

12. The method according to claim 11, wherein the using step (h) comprises
(j) recirculating heated gas used in step (i) to provide the thermal activity in the first desorption stage.

13. The method according to claim 7, wherein the cooling step (j) comprises
(k) introducing the effluent-impurity vapor from the step (i) into the cool-down stage.

14. The method according to claim 7, wherein the thermally processing step
(e) produces a dried form of regenerated adsorbent and the cooling step (j) comprises (k) cooling the regenerated adsorbent sufficiently to overcome heat evolved from wetting the dried form of regenerated adsorbent.

15. The method according to claim 1, wherein the recycling step (f) comprises
(g) introducing the regenerated adsorbent from step (e) into an upper part of the adsorber vessel to countercurrent contact the liquid stream as the liquid stream flows upward through the adsorber vessel.

16. The method according to claim 1, wherein the flowing step (a) entails use of at least 96 weight percent or greater of the porous adsorbent particulates in a narrow range between 14 to 35 Tyler mesh size.

17. The method according to claim 1, wherein the liquid stream comprises a liquid olefinic hydrocarbon feed stream with a limited boiling range of less than 250 degrees centigrade for 98 volume percent of the liquid stream, the liquid stream having limited impurities less than approximately 8000 ppm by weight of sulfur, and the purified liquid stream that results from the contacting step (b) comprises less than 2 percent by weight of the sulfur in the liquid stream.

18. The method according to claim 7 comprising:
(k) hydrogenating condensate from the effluent-liquid vapor produced in the using step (h) to produce hydrogenated condensate; and
(l) combining the hydrogenated condensate with the liquid stream for use in the flowing step (a).

19. The method according to claim 1, wherein the liquid stream is a hydrocarbon liquid comprised of at least 98% by volume of compounds having carbon numbers ranging from 3 to 15, and comprising a step ((g) of maintaining the liquid stream at a temperature less than 40° C. for use in the flowing step (a).

20. The method according to claim 21, wherein the temperature is less than 20° C.

21. The method according to claim 1, wherein the first upright adsorber vessel is constructed in a plurality of adsorber stages in descending order from a terminal adsorption stage having a settled bed height less than 30 meters to a feed entry adsorption stage having a settled bed height less than seven meters, and the flowing step (a) comprises flowing the liquid stream at a flow rate establishing the fluidized bed performance limited to no greater than 10 percent bed expansion in each of the plurality of adsorber stages.

22. The method according to claim 1, including use of a second upright adsorber vessel serially connected to the first upright adsorber vessel for receipt of the purified liquid stream, and the flowing step (a) comprises flowing the purified liquid stream from the first adsorber vessel downward to provide gravity assisted flow through the second adsorber vessel.

23. The method according to claim 1, comprising:
(g) screening the regenerated adsorbent to produce fines; and
(h) using the fines produced in the screening step (g) to filter the liquid stream prior to the flowing step (a) the fresh feed to be treated to ensure removal of scale and other possible debris or non-regenerable poisons from contaminating the circulating adsorbent used.

24. The method according to claim 1, wherein the liquid stream used in the flowing step (a) contains mercaptan impurities in a concentration greater than 0.5 ppm by weight, and the contacting step (c) results in the purified liquid stream having mercaptan impurities having a concentration less than 0.5 ppm by weight in the purified liquid stream.

25. The method according to claim 1, wherein the liquid stream used in the flowing step (a) includes nitrogen-containing impurities in a concentration greater than 0.3 ppm by weight, and the contacting step (c) results in the purified liquid stream having nitrogen-containing impurities in a concentration less than 0.3 ppm by weight

26. The method according to claim 1, wherein the processing step (e) comprises (g) heating the adsorbent in a regenerator vessel hat includes a thin cross-flow.

27. In a facility for use in removing impurities from a liquid stream by contacting the liquid stream with an adsorbent in an adsorber vessel and removing impurities from the adsorbent by the action of a regenerator vessel precedent to recycling of the adsorbent through the adsorber vessel, the improvement comprising:
the adsorber vessel containing porous adsorbent particulates comprised of a 8 to 48 Tyler mesh range with a size distribution and configured for establishing fluidized bed performance with bed expansion no greater than 10 percent.

28. The facility of claim 27, wherein the adsorber vessel comprises:
a plurality of adsorption stages in sequential order from a terminal adsorption stage to a feed entry adsorption stage, each of the adsorption stages separated in sequence from the next adsorption stage by a flow distributor that permits flow of the liquid stream while retaining the porous adsorbent particulates that settle atop the flow distributor under gravitational influence, each of the adsorption stages configured for the fluidized bed performance;
the adsorber vessel having a first inlet for receipt of the liquid stream and a second inlet located remotely from the first inlet for receipt of adsorbent, the first and second inlets being deployed for contra-directional flow between the liquid stream and the adsorbent through the adsorber vessel; and
means for transferring adsorbent between the respective adsorber stages while maintaining the fluidized bed performance.

29. The facility of claim 28, comprising a means for sensing an upper level of the fluidized bed in each of the adsorption stage by the action of a nuclear density device and for controlling the position of the upper level by the action of flow valves to withdraw the impurity-bound adsorbent from each of the adsorption stages.

30. The facility of claim 29, comprising a liquid-solid separator interposed between the adsorber vessel and the regenerator vessel for separating liquids from the adsorbent.

31. The facility of claim 28, wherein the regenerator vessel comprises at least
a first desorption stage with a first heater configured to evaporate a first fraction of liquid from the adsorbent and produce effluent-liquid vapor,
a second desorption stage with a second heater configured to evaporate a second fraction of liquid from the adsorbent and produce effluent-impurity vapor, and
a cool-down stage.

32. The facility of claim 31, comprising
a cooler configured to condense the effluent-liquid vapor from the first desorption stage, and
means for combining liquid output from the cooler with the liquid stream.

33. The facility of claim 31, wherein the first heater is configured to accept recirculated gas from the second heater.

34. A method of treating a liquid stream which contains impurities in limited amounts with a solid adsorbent having an affinity for the impurities compared with other components in the liquid to reduce the impurities significantly for the adsorber-treated product with the following steps:
providing a liquid fresh feed stream to the adsorber suitably cooled, with solid contaminants no greater than 0. 10 weight percent and suitably free from agents which might degrade the impurity removal performance after long term regeneration;
providing a porous, particulate adsorbent within a 8 to 48 Tyler mesh range and in a suitably narrow fraction whereby size segregation is acceptable when subject to fluidization with bed expansions no greater than 10 percent with the liquid feed stream or liquid effluent from preceding adsorption stages;
providing an adsorption section consisting of liquid fluidized stages with a bottom inlet and an upper outlet in the adsorber vessel and the same if more than one adsorber vessel;
introducing said adsorbent stream into the upper part of the last adsorption stage to countercurrent contact the said liquid stream that flows upward from a preceding adsorption stage until the said liquid fresh feed stream enters the fresh feed adsorption stage;
spent adsorbent is withdrawn as a slurry near the inlet distributor of the first adsorption feed stage to proceed to a liquid-solid separator that separates the liquid forming the slurry for return as liquid to the adsorption feed stage whereas the solids separated enter a regeneration section that has at least two desorption zones and a cool-down zone for the regeneration of the spent adsorbent stream; providing a desorption section with two or more desorption zones which first continuously desorbs a significant portion of the desired liquid product initially in the spent adsorbent pores of the adsorbent by circulating gas after cooling and condensing most of the liquid released, with impurity concentration lower than that of the fresh feed, by stripping and heating with this recirculated gas with suitable makeup gas to a higher temperature than the solids leaving the recycle liquid desorption zone, but significantly lower in temperature than that used for the heated gas that enters the final desorption zone and which sufficiently removes the impurities from the solids as a concentrated impurity stream;
introducing desorbed adsorbents from the final desorption zone into the cool-down zone of the regenerator;
introducing a reactivating gas sufficiently free from any agents that might interfere with the desired adsorption of impurities to accomplish cool-down of the absorbent solids leaving the final desorption zone with cross flow contact using a plurality of countercurrent contacts to the hot regenerated adsorbent leaving the final impurity stage downwardly flowing for the transfer of heat to the reactivating gas leaving;
causing the said heated gas to enter a heater for heating to the required temperature to accomplish sufficiently the desorption of impurities in the final desorption zone on a once through basis;
providing said regenerated adsorbent stream from said cool-down zone with sufficient cooling to remove the heat of wetting, preferably as a slurry with the final desorption liquid before introducing into the adsorber section;
recirculating the cooled said regenerated adsorbent stream for introduction into said adsorption section.

35. Method of treating as set forth in claim 34 wherein 96 weight percent or greater of the particulate adsorbents are in the 14 to 35 Tyler mesh range.

36. The method of treating a liquid olefinic hydrocarbon feed stream with a limited boiling range approximating less than 250 degrees centigrade for the 98 volume percent point with limited impurities less than approximately 8000 ppmw of sulfur to remove more than 98 weight percent of sulfur entering as feed as set forth in claim 1 wherein the solids leaving recycle liquid desorption zone generally are limited to less than 200 degrees centigrade, with the resulting regeneration zone condensate containing most of the olefin returned to the adsorption section to become part of the adsorber treated product.

37. Method as set forth in claim 36 wherein the dienes in the recycled liquid condensate from recycle desorption zone of the regenerator are hydrogenated selectively with a nickel or palladium containing catalyst, or other suitable catalyst, with limited hydrogen makeup, sufficiently moderate temperatures to avoid green oil formation or saturate olefins, and pressures below 300 psig before entering the adsorption section.

38. Treating a liquid hydrocarbon ranging from 3 to 15 in carbon numbers as set forth in claim 1 wherein the feed entering the adsorption section is not greater than 40 degrees centigrade and preferably below 20 degrees centigrade.

39. Treating a liquid hydrocarbon feed ranging from 3 to 15 in carbon numbers as set forth in claim 1 with a hydrogen containing gas as the reactivating medium and having the vapors leaving the final desorption zone to enter a vapor phase reactor for the hydrogenation of most of the entering heteroatoms with the resulting reactor effluent being condensed with cooling to enter a separator wherein the heteroatom concentrated liquid is further separated. The gas stream from the separator may be treated for heteroatom removal and recycled as part of the reactivating gas to the adsorption section. The limited amount of liquid, generally less than 4 percent of the hydrocarbon fresh feed, to the adsorption section may be stripped of light ends and have the mono aromatic concentrate normally boiling up to approximately 190 degrees centigrade separated as gasoline with possible recycle to the latter stages of the adsorption section for more complete sulfur removal. Most of the higher boiling residual naphthalene or unhydrogenated benzothiophenes or quinoline is separated by distillation with possible routing to a higher pressure hydrogenation unit such as a diesel hydrotreater.

40. Treating a liquid hydrocarbon feed as in claim 39 wherein the hydrogenation effluent gas is heat exchanged with the recirculating gas that enters the recycle liquid desorption zone of the regenerator.

41. Treating a fresh liquid hydrocarbon feed as set forth in claim 34 with the condensed liquid from the recycle liquid desorption zone or after undergoing diene removal as set forth in claim 4 being injected into the latter stages of the adsorption section.

42. Treating a liquid hydrocarbon feed ranging from 3 to 15 in carbon numbers as set forth in claim 1 with the effluent vapors from the final desorption zone of the regenerator heat exchanged and cooled to produce a concentrated heteroatom liquid that may be biologically desulfurized or hydrogenated.

43. Treating a liquid hydrocarbon feed as set forth in claim 42 wherein the effluent vapors from the heteroatom concentrate desorption zone of the regenerator is heat exchanged with the recirculating gas that enters the recycle desorption zone of the regenerator.

44. Treating a feed as set forth in claim 34 wherein the adsorbent particles are spherical with the original adsorbent and makeup being predominantly greater than 10 Tyler mesh and less than 45 Tyler mesh, but with a particle diameter range of 1.5 for more than 96 percent of the particles.

45. Treating a feed as set forth in claim 34 wherein a limited amount of a hydrogen containing gas totaling less than 10 percent of the reactivating gas to the cool-down zone of the regenerator is used as gas makeup to the recycle liquid desorption zone, while nitrogen or other suitable gas is used as the reactivating gas to the cool-down zone of the regenerator.

46. Method of treating as set forth in claim 34 with a limited number of fluidized stages by limiting the bed expansion in the fluidized zones of the adsorption section with less than seven meter settled bed height in the feed entry stage and less than thirty meter settled bed height in the final adsorption stage.

47. For more than one adsorption vessel in the adsorption section as set forth in claim 1 the use of part of the liquid adsorption stream from the preceding adsorption vessel closer to the fresh feed as a liquid lift for the withdrawn slurry from the succeeding vessel to reduce the pumping head required for the major part of the liquid adsorption stream that enters as feed to the succeeding vessel.

48. Use of an enlarged diameter at the top of an adsorption vessel as set forth in claim 1 to facilitate separation of the solids from the liquid while reducing the height for a given bed inventory in the top stage of an adsorption vessel and permitting lift liquid to be used without any increase in superficial velocity for the liquid in the fluidized beds below the enlarged diameter section.

49. Use of a smaller diameter activated alumina or other suitable adsorbent in an upflow vessel as a filtering medium for the fresh feed as set forth in claim 1 to ensure removal of scale or other possible debris from dirtier feeds, such as coker or visbreaker distillates, and to preclude nonregenerable poisons such as silicon compounds or iron from contaminating the circulating adsorbent used.

50. Use of screened, smaller diameter adsorbent solids discarded long term from the regenerator as set forth in claim 1 as a filtering medium for the fresh feed to be treated to ensure removal of scale and other possible debris or non-regenerable poisons from contaminating the circulating adsorbent used.

51. The method of treating a liquid hydrocarbon stream as fresh feed as set forth in claim 1 to remove corrosive agents such as mercaptans below 0.5 ppmw for the adsorber treated product so that the product passes any copper strip or doctor test.

52. The method of treating a dirty, liquid hydrocarbon stream, such as a coker or visbreaker gasoline feedstream, as set forth in claim 1, wherein a clear water-white product, free from any noxious odors is produced as the adsorber treated product.

53. The method of treating a liquid hydrocarbon feed as set forth in claim 34 for nitrogen reduction to less than 0.3 ppmw nitrogen in the adsorber treated product.

54. The method of treating as set forth in claim 34 wherein gravity is employed in the adsorption vessel for transferring between stages using a nuclear device for interface fluid level detection for the solids containing bed in a stage and control of the solids transfer by varying the opening in the conduit from the bottom such as with a pinch valve from the bed distributor of the upper stage that contains openings smaller than the fluidized particles which permit liquid effluent from the stage below to enter the succeeding stage. The slurry conduit enters below the near normal expanded solids bed height. The differential for transfer of solids is provided by slurry density in the conduit versus clear liquid density available below the upper stage distributor.

55. The method of treating as set forth in claim 54 wherein the slurry conduit is located outside the adsorption vessel so that external access to the transfer valve is facilitated and interference with even, smooth distribution of the liquid entering the distributor above is minimal.

56. The method of treating as set forth in claim 34 wherein gravity transfers the solids in a continuous manner with a thin, cross-flow bed less than 0.5 meter in thickness for gas cross-flow with suitable baffling on the gas side and with controlled gas flow rates for gas cross-flow in the various zones of the regenerator. This minimizes the residence of solid particles subject to possible coking temperatures in the desorption zones while avoiding readsorption due to significantly colder temperature of the particles at the gas outlet due to limited cross-flow bed length.

57. The method of treating a fresh feed as set forth in claim 34 wherein liquid feeds to the adsorber are cooled below ambient particularly for low impurity adsorber treated product, such as below 5 ppmw sulfur, while treating any catalytic cracker fall boiling range gasoline or derived fractions, pyrolysis gasoline or other olefinic fresh feedstocks.
